(19) United States
(12) Patent Application Publication
(10) Pub. No.: US 2011/0126534 A1
(43) Pub. Date: Jun. 2, 2011

(54) HYBRID BRAKE SYSTEM

(75) Inventors: Chang Bok KO, Kyungki-Do (KR); Hong Ki Kim, Gyeonggi-do (KR); Seung Hyup Bae, Chungnam (KR)

(73) Assignee: MANDO CORPORATION

(21) Appl. No.: 12/957,954

(22) Filed: Dec. 1, 2010

(30) Foreign Application Priority Data
Dec. 1, 2009 (KR) 10-2009-117615

(51) Int. Cl. F15B 7/00

(52) U.S. Cl. 60/533

(57) ABSTRACT

Disclosed is a hybrid brake system equipped with a pedal simulator having a parallel structure. The hybrid brake system includes an input shaft connected to a brake pedal, a pedal simulator provided therein with a control plunger connected with the input shaft, a master cylinder communicating with the pedal simulator and provided therein with first and second pistons, an oil supply part supplying oil to the pedal simulator and the master cylinder, and a boosting part communicating with the pedal simulator and forming repulsive force when the brake pedal is stepped on.

### CROSS-REFERENCE TO RELATED APPLICATIONS

This application claims the benefit of Korean Patent Application No. 10-2009-0117615, filed on Dec. 1, 2009, in the Korean Intellectual Property Office, the disclosure of which is incorporated herein by reference.

### BACKGROUND

1. Field

The disclosure relates to a hybrid brake system, and more particularly to a hybrid brake system capable of improving brake pedal feeling by employing a pedal simulator having a parallel structure.

2. Description of the Related Art

In general, when a driver steps on a brake pedal, a hydraulic active booster (HAB) detects displacement of the brake pedal from a pedal displacement sensor and closes a shut-off valve to close a fluid path between a master cylinder of a pedal simulator and a wheel, and an electronic control unit (ECU) calculates wheel pressure according to a pressure signal of a pressure sensor to control pressure of each wheel through an independent feedback control.

When the HAB fails, the shut-off valve is switched into a normally open (NO) state, so liquid pressure of the master cylinder corresponding to pedal force of the driver is transferred to a wheel cylinder so that the minimum braking operation can be performed upon the system failure.

In such a HAB, if the driver steps on the brake pedal, an input shaft is moved and the ECU detects the movement of the input shaft, so fluid stored in an accumulator is transferred to the master cylinder to generate the liquid pressure in the master cylinder. However, if the pressure of the master cylinder is changed during the regenerative braking operation, the pressure variation may be transferred to the brake pedal, thereby deteriorating the pedal feeling.

### SUMMARY

Accordingly, it is an aspect of the disclosure to provide a hybrid brake system equipped with a pedal simulator having a parallel structure capable of increasing the brake pedal feeling.

Additional aspects and/or advantages of the disclosure will be set forth in part in the description which follows and, in part, will be apparent from the description, or may be learned by practice of the disclosure.

The foregoing and/or other aspects of the disclosure are achieved by providing a hybrid brake system. The hybrid brake system includes an input shaft connected to a brake pedal, a pedal simulator provided therein with a control plunger connected with the input shaft, a master cylinder communicating with the pedal simulator and provided therein with first and second pistons, an oil supply part supplying oil to the pedal simulator and the master cylinder, and a boosting part communicating with the pedal simulator and forming repulsive force when the brake pedal is pressed.

The pedal simulator includes a simulator housing having a chamber for receiving the control plunger, and wherein the boosting part is provided at a lower portion of the simulator housing and has a parallel structure.

The boosting part includes a cylinder communicating the pedal cylinder, a spring retainer, which slides upward or downward in the cylinder, a compression spring compressed by the spring retainer, and a housing cap supporting the compression spring.

The simulator housing is provided therein a first oil port for supporting oil into the cylinder.

The master cylinder includes a second oil port for supplying oil to a space between the second piston and an internal surface of the master cylinder.

The second piston is a booster piston to move the first piston while moving forward by oil received therein through the second oil port.

The first piston has a recess part recessed inward from a rear end of the first piston, a front end portion of the control plunger is inserted into the recess part, and a gap is formed between the recess part and the control plunger.

As described above, according to the hybrid brake system of the disclosure, hydraulic pressure can be independently controlled by the pedal simulator having a parallel structure, so that brake pedal feeling can be improved.

Since the pedal simulator is installed separately from the housing, the pedal simulator can be freely designed, and can be easily tuned.

### BRIEF DESCRIPTION OF THE DRAWINGS

These and/or other aspects will become apparent and more readily appreciated from the following description of the embodiments, taken in conjunction with the accompanying drawings of which:

FIG. 1 is a schematic perspective view showing a hybrid brake system according to the disclosure;

FIG. 2 is a schematic sectional view showing the hybrid brake system according to the disclosure;

FIG. 3 is a partial sectional view of FIG. 2; and

FIG. 4 is a schematic view showing the operation of the hybrid brake system according to the disclosure.

### DETAILED DESCRIPTION

Reference will now be made in detail to the embodiments, examples of which are illustrated in the accompanying drawings, wherein like reference numerals refer to the like elements throughout. The embodiments are described below to explain the disclosure by referring to the figures.

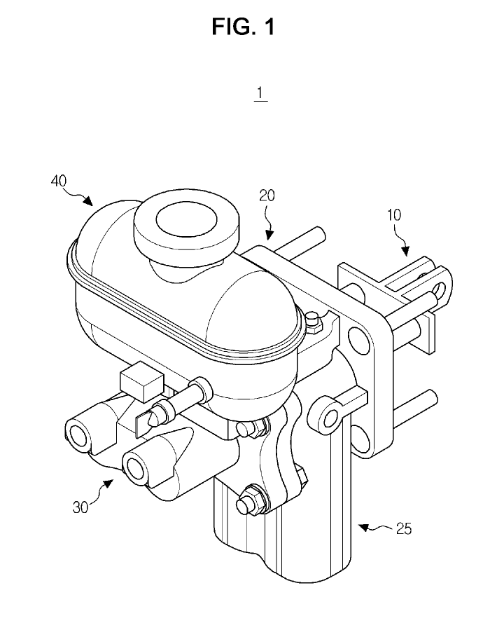

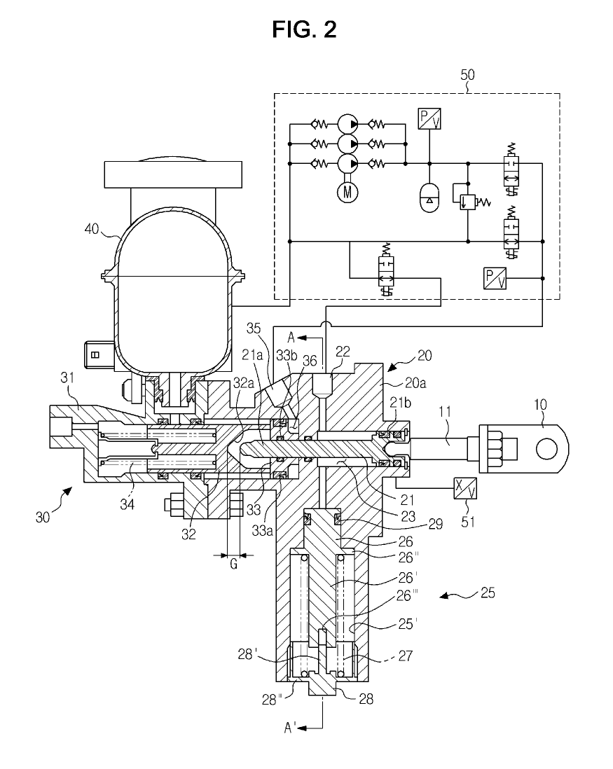

As shown in FIGS. 1 to 2, a hybrid brake system 1 according to the disclosure includes a brake pedal 10 manipulated by a driver in braking, an input shaft 11 connected to the brake pedal 10, a pedal simulator 20 providing repulsive force against the brake pedal 10, a master cylinder 30 connected to the pedal simulator 20 to transfer braking pressure to a wheel brake (not shown) as the braking pressure is generated by the brake pedal 10, an oil reservoir 40 storing oil, and an oil supply part 50 supplying the oil of the oil reservoir 40 to the master cylinder 30 and the pedal simulator 20.

The input shaft 11 is linked with the brake pedal 10 and inserted into a rear end of a control plunger 21, which will be described later, so that the control plunger 21 can be moved toward the direction of the input shaft 11 in a simulator housing 20a.

The master cylinder 30 includes a cylinder housing 31 having a space to store oil therein, and an oil reservoir 40 is coupled with the upper portion of the cylinder housing 31.

One end surface of the cylinder housing 31 is open and coupled with the pedal simulator 20 to be described later.

The cylinder housing 31 of the master cylinder 30 includes a second piston 33 into which the control plunger 21 is inserted, a first piston 32 slidably provided by the second piston 33, and an elastic spring 34 interposed between an inner wall of the cylinder housing 31 and the first piston 32 to elastically support the cylinder housing 31 and the first piston 31.

A second oil port 35 is provided at an upper portion of the master cylinder 30 to supply oil into the first chamber 36 between the second piston 33 and the inner surface of the master cylinder 30.

The second piston 33 is inserted into a front end portion 21a of the control plunger 21, and a sealing member 33b is provided between the second piston 33 and the control plunger 21.

A recess part 32a is formed inward from one end portion of the first piston 32, and a gap G is formed between the recess part 32a and the front end portion 21a of the control plunger 21.

In the normal operation, force applied by the input shaft 11 connected to the brake pedal 10 does not deliver to the control plunger 21 and the first piston 32 due to the gap G.

In other words, in the case of the regenerative braking, even if the first piston 32 moves backward, since the control plunger 21 does not make direct contact with the first piston 32, the pedal feeling of the brake pedal 10 is not deteriorated.

Sealing members 33a and 21b are provided at an outer portion of the control plunger 21 to seal the gap with the first piston 32 and the gap with the internal lateral surface of the simulator housing 20a.

The pedal simulator 20 includes the simulator housing 20a coupled with the open end of the cylinder housing 31, and a second chamber 23 is formed in the simulator housing 20a into which the control plunger 21 slidably moves.

A first oil port 22 is formed at an upper portion of the simulator housing 20a to supply oil from the oil supply part 50 to the second chamber 23.

A boosting part 25 having a parallel structure is provided at a lower portion of the simulator housing 20a.

The boosting part 25 is provided at one side thereof with a first boosting part 25a and provided at an opposite side thereof with a second boosting part 25b, in which the first and second boosting parts 25a and 25b are provided in parallel to each other. Pressure control is independently achieved by the first and second boosting parts 25a and 25b, so that braking force can be independently controlled.

The first boosting part 25a includes a cylinder 25a′ communicating with the second chamber 23 of the simulator housing 20a, a spring retainer 26 that can be slid upward or downward in the cylinder 25a′, a compression spring 27 compressed by the spring retainer 26, and a housing cap 28 supporting the spring retainer 26.

A third chamber 25″ is formed inside the cylinder 25a′, that is, in a space between a top surface of the inside of the cylinder 25a′ and the upper end of the spring retainer 26, and oil introduced through the first oil port 22 is supplied to the third chamber 25″ through the second chamber 23.

The oil supply part 50 includes a motor M controlled by an ECU (electronic control unit) (not shown), a pump operated by the motor M, and an accumulator to temporarily store high-pressure oil generated by the pump.

The motor M is controlled by the ECU (not shown), and the ECU adjusts a pressure corresponding to the pedal force of a driver according to the pressing degree of the brake pedal 10 detected by the pedal displacement sensor 51 by controlling the motor M.

A pressure sensor (not shown) is provided at an outlet of the accumulator to measure the oil pressure of the accumulator, so that the oil pressure measured through the pressure sensor is compared with the preset pressure. If the measured oil pressure is lower than the present pressure, the pump is driven so that the accumulator can be filled with oil.

In addition, the ECU transfers oil filled in the accumulator into the first to third chambers 36, 23, and 25b through the first and second oil ports 22 and 25 to make hydraulic pressure corresponding to the pedal force of the driver.

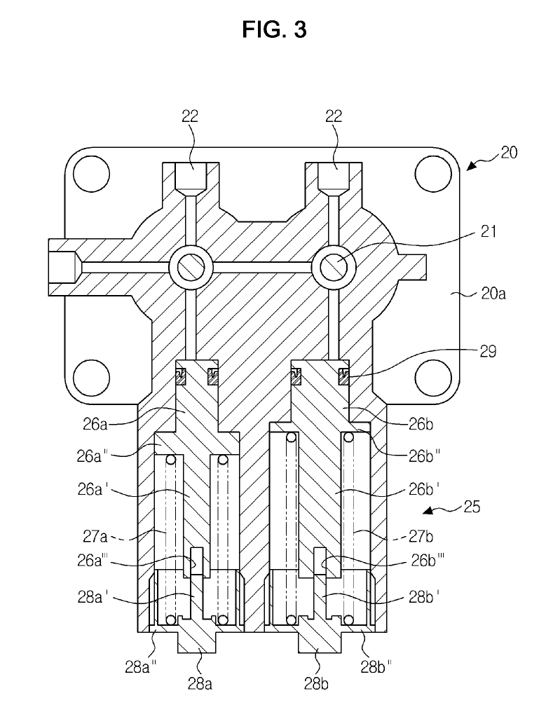

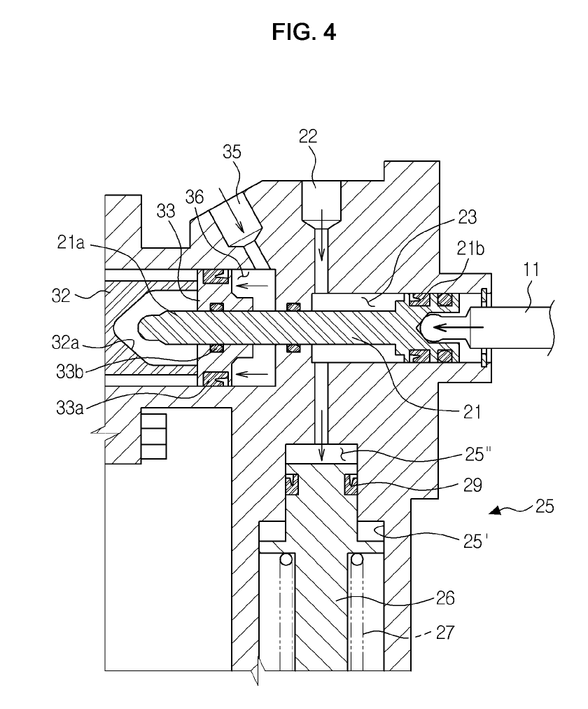

As shown in FIGS. 3 to 4, the spring retainer 26 moves upward or downward inside the cylinder 25′ by oil supplied from the oil supply part 50 through the first oil port 22 in normal operation.

The spring retainer 26 includes a body 26′ having a cylindrical shape, a flange part 26″ provided at an upper portion of the body 26′, and a guide groove 26″ recessed inward from a lower end of the spring retainer 26.

Sealing members 29 are provided between the upper portion of the spring retainer 26 and the cylinder 25′.

The body 26′ of the spring retainer 26 has an inner diameter less than that of the cylinder 25′, and the flange part 26″ has a size corresponding to the inner diameter of the cylinder 25′ to support the compression spring 27.

The housing cap 28 is provided at an open lower end of the cylinder 25′. The housing cap 28 includes a support part 28″ having a diameter corresponding to an inner diameter of the cylinder 25′ and a guide 28′ protruding upward from the central portion of the support part 28″ and inserted into a guide groove 26″ of the spring retainer 26.

The compression spring 27 is installed at a rear end of the cylinder 25′ and interposed between the support part 28″ of the housing cap 28 and the flange part 26a″ of the spring retainer 26.

The spring constant, the acting area, and mounting load of the compression spring 27 are variable.

Accordingly, oil supplied through the first oil port 22 of the simulator housing 20a is introduced into the third chamber 25″ through the second chamber 23, and the spring retainer 26 is moved downward by the oil introduced into the third chamber 25″.

If the compression spring 27 is compressed by the movement of the spring retainer 26, the compression spring 27 has repulsive force, so that the driver may have brake pedal feeling.

In this case, since the boosting part 25 includes the first and second boosting parts 25a and 25b installed in parallel to each other, pressure can be independently supplied to each chamber, so that braking force can be independently controlled.

Since the first and second boosting parts 25a and 25b have the same structure and operation, the details thereof will be omitted.

Although few embodiments have been shown and described, it would be appreciated by those skilled in the art that changes may be made in these embodiments without departing from the principles and spirit of the disclosure, the scope of which is defined in the claims and their equivalents.

What is claimed is:

1. A hybrid brake system comprising:
an input shaft connected to a brake pedal;
a pedal simulator provided therein with a control plunger connected with the input shaft;
a master cylinder communicating with the pedal simulator and provided therein with first and second pistons;
an oil supply part supplying oil to the pedal simulator and the master cylinder; and
a boosting part communicating with the pedal simulator and generating repulsive force when the brake pedal is pressed.

2. The hybrid brake system of claim 1, wherein the pedal simulator includes a simulator housing having a chamber for receiving the control plunger, and the boosting part is provided at a lower portion of the simulator housing and has a parallel structure.

3. The hybrid brake system of claim 1, wherein the boosting part includes a cylinder communicating the pedal cylinder, a spring retainer, which slides upward or downward in the cylinder, a compression spring compressed by the spring retainer, and a housing cap supporting the compression spring.

4. The hybrid brake system of claim 2, wherein the simulator housing is provided therein a first oil port for supporting oil into the cylinder.

5. The hybrid brake system of claim 1, wherein the master cylinder includes a second oil port for supplying oil to a space between the second piston and an internal surface of the master cylinder.

6. The hybrid brake system of claim 5, wherein the second piston is a booster piston to move the first piston while moving forward by oil received therein through the second oil port.

7. The hybrid brake system of claim 1, wherein the first piston has a recess part recessed inward from a rear end of the first piston, a front end portion of the control plunger is inserted into the recess part, and a gap is formed between the recess part and the control plunger.
